(19) United States
(12) Patent Application Publication
(10) Pub. No.: US 2007/0080556 A1
(43) Pub. Date: Apr. 12, 2007

(54) Removable sun visor extension

(76) Inventor: Celia Milano, North Brunswick, NJ (US)

Correspondence Address: Diane Dunn McKay, Esq.;Mathews, Shepherd, McKay & Bruneau, P.A., Suite 306, 100 Thanet Circle, Princeton, NJ, 08540, US

(21) Appl. No.: 11/245,570

(22) Filed: Oct. 7, 2005

(51) Int. Cl. B60J 3/00

(52) U.S. Cl. 296/97.8

(57) ABSTRACT

The present invention relates to a sun visor extension which is removably mountable to a rearview mirror. The sun visor extension includes a housing and a pair of arms being slideably extendible from an opening in the housing. In the extended position, the arms extend between visors of the vehicle to provide blocking or shading of sun and glare though the windshield or above the rearview mirror. The arms can be formed of plastic or polarized plastic. A mounting member is attached to the housing for mounting the housing to a portion of the rearview mirror. For example, the mounting means can be a first portion of hook and loop material attached to the housing and a second portion of hook and loop material attached to the rearview mirror. The present invention relates to a method for blocking an area between a pair of sun visors comprising the steps of mounting a sun visor extension to a rearview mirror, the sun visor extension comprising a housing, a pair of arms slideably extending from an opening in the housing, and a mounting means attached to the housing for mounting the housing to a portion of a rearview mirror.

### BACKGROUND OF THE INVENTION

1. Field of the Invention

The present invention relates to a removable sun visor extension which can be expeditiously attached to a rearview mirror or above a rearview mirror of a vehicle.

2. Description of Related Art

Conventional sun visors for automobiles include a pair of sun visors mounted to the vehicle's windshield headliner. A gap extends between the pair of sun visors around the rearview mirror.

Several attempts have been made for providing a sun visor extension to provide a complete screen across the upper part of the vehicle windshield in which an extension panel is attached to or extends from the sun visor. For example U.S. Pat. No. 6,682,122 describes a sun visor system including a sliding carrier visor having a stowed position within a headliner of a vehicle and a deployed position running laterally along a portion of the visor unit between the rearview mirror and the sun visors. U.S. Pat. No. 4,323,275 describes a housing attached to and swingable with a vehicle sun visor including auxiliary visors withdrawable toward the rearview mirror. U.S. Pat. No. 4,836,599 describes a vehicle visor installation in which a box is permanently attached to a rearview mirror. The box includes side walls which extend from the edge of the rearview mirror to the visor panel. These patents have the drawback of being permanently mounted and being costly to manufacture.

Portable sun visors have been described. U.S. Pat. No. 4,958,879 describes a portable compact sun visor in which a slot is positioned between a pair of hinged rectangular members. The slot is received over the rearview mirror. This patent has the disadvantage that it is difficult to balance the sun visor on the rearview mirror and sun glare can penetrate the driver through the slot. It is desirable to provide a removable sun visor extension which can be expeditiously attached to a rearview mirror of any type of vehicle and provide complete blocking of sun glare and having low manufacturing costs.

### SUMMARY OF THE INVENTION

The present invention relates to a sun visor extension which is removably mountable to a rearview mirror or above the rearview mirror. The sun visor extension includes a housing and a pair of arms being slideably extendible from an opening in the housing. In the extended position, the arms extend between visors of the vehicle to provide blocking or shading of sun and glare though the windshield. The arms can be formed of plastic or polarized plastic. A mounting member is attached to the housing for mounting the housing to a portion of the rearview mirror. For example, the mounting means can be a first portion of hook and loop material attached to the housing and a second portion of hook and loop material attached to the rearview mirror. Alternatively, the second portion of hook and loop material can be attached to a mountable surface above the rearview mirror, such as the interior roof of the vehicle or the windshield.

The present invention relates to a method for blocking an area between a pair of sun visors comprising the steps of mounting a sun visor extension to a rearview mirror, the sun visor extension comprising a housing, a pair of arms slideably extending from an opening in the housing, and a mounting means attached to the housing for mounting the housing to a portion of a rearview mirror or above the rearview mirror.

The invention will be more fully described by reference to the following drawings.

### BRIEF DESCRIPTION OF THE DRAWINGS

FIG. 1 is a schematic diagram of a front view of a sun visor extension in an extended position.

FIG. 2 is a schematic diagram of a rearview of the sun visor extension in a non-extended position.

FIG. 3 is a schematic diagram of the sun visor extension attached to a rearview mirror and extending between sun visors.

FIG. 4 is a schematic diagram of the sun visor extension attached above a rearview mirror and extending between sun visors.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

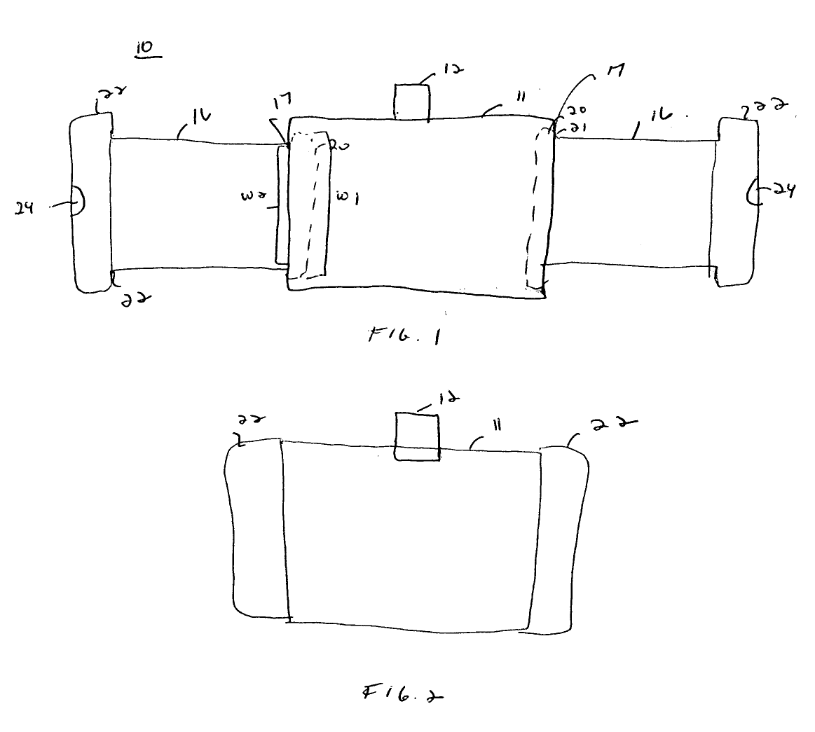

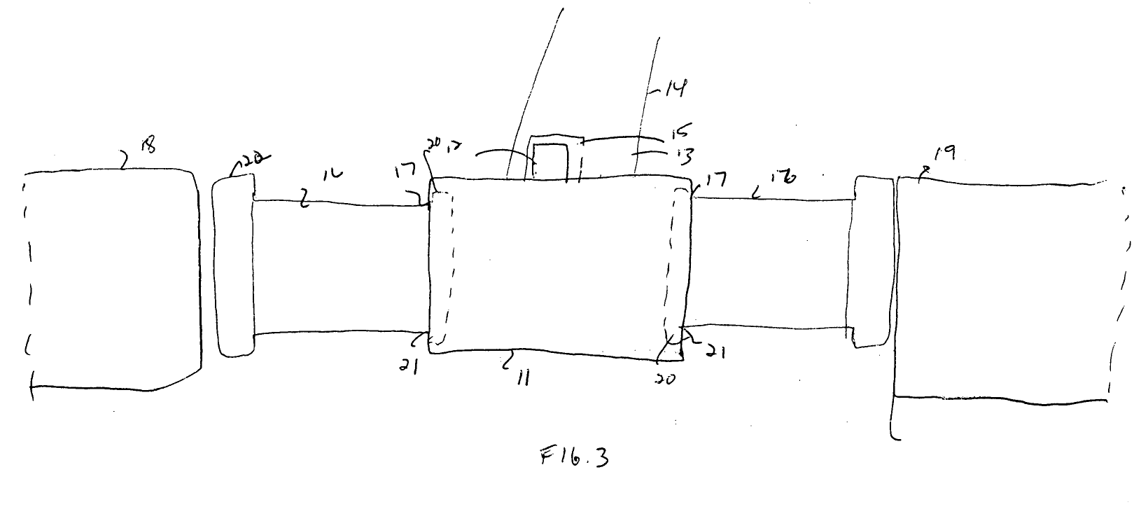

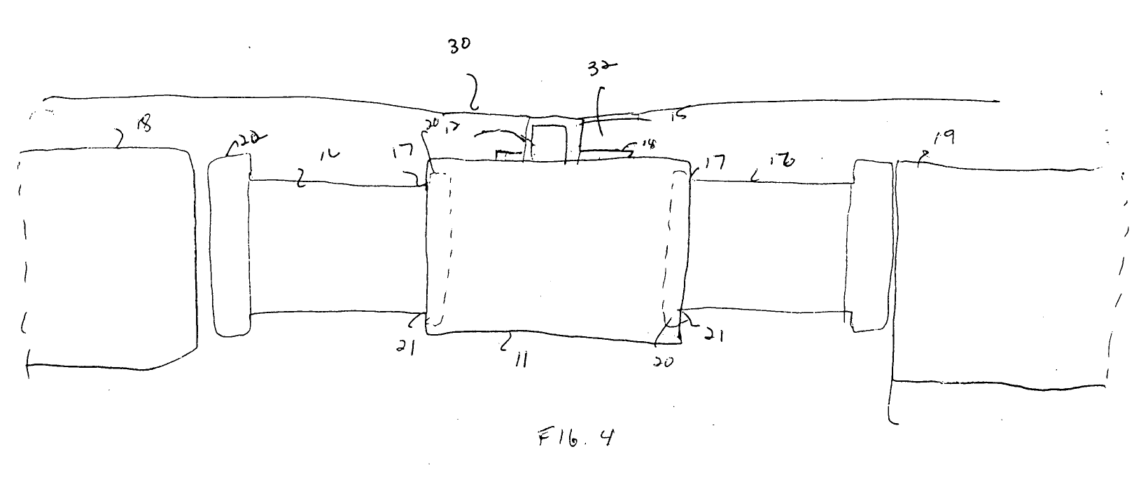

FIGS. 1 and 2 are schematic diagrams of sun visor extension 10 in accordance with the teachings of the present invention. Sun visor extension 10 includes mounting member 12 attached to housing 11 for mounting sun visor extension 10 to rearview mirror 14. Sun visor extension 10 is removably mounted to portion 13 of rearview mirror 14 using mounting member 12, as shown in FIG. 3. Mounting member 15 can be attached to portion 13 of rearview mirror 14. For example, portion 13 of rearview mirror 14 can be a stem or base of the rearview mirror. In one embodiment, mounting member 12 and mounting member 15 can be formed of a hook and loop material for coupling mounting member 12 to mounting member 15.

Alternatively, sun visor extension can be attached above rearview mirror 14, as shown in FIG. 4. Mounting member 15 can be attached to interior roof 30. Alternatively, mounting member 15 can be attached to windshield 32 above the rearview mirror.

Arms 16 can be slideably extended from opening 17 in housing 11 between sun visors 18, 19 positioned respectively on either side of a rearview mirror 14, as shown in FIG. 1.

End portion 20 can be attached or integral in housing 11 to inner end 21 of arm 16. End portion 20 has a larger width W₁ than W₂ of opening 17 to prevent end portion 20 from pulling out of housing 11.

End portion 22 is attached or integral with to outer end 22 of arm 16. End portion 22 can be formed of a thicker material than arm 16 to provide support. Indentation 24 can be formed in end portion 22. Indentation 24 can be used for receiving a finger or thumb of a user to allow the user to grip end portion 22 and extend arm 16 from housing 11. Arm 16, end portion 20 and end portion 22 can be formed of an opaque material for preventing sun rays or glare from striking the eyes of the driver. For example, arm 16 and end portion 22 can be formed of one or more layers of polarized plastic for preventing sun from shining through area A₁ between sun visors 18 and 19. Housing 11 can be formed, for example, of plastic, polarized plastic or cardboard.

In an expanded configuration, arms 16 extend between sun visors 18 and 19, as shown in FIG. 1 and FIG. 2. In a closed position, as shown in FIG. 2, arms 16 are slideably retracted into housing 11. In the closed position, sun visor extension 10 can be easily carried on a person or persons' belongings or stored within a compartment of a vehicle.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A sun visor extension comprising:
a housing;
a pair of arms slideably extending from an opening in said housing; and
a mounting means attached to said housing adapted for mounting said housing to a portion of a rearview mirror or above the rearview mirror.

2. The sun visor extension of claim 1 wherein said mounting means comprises:
a first portion of a hook and loop material attached to said housing; and
a second portion of a hook and loop material adapted to be attached to a portion of the rearview mirror.

3. The sun visor extension of claim 1 wherein a first end portion is attached or integral with an inner end of each of said arms, said first end portion having a width which is larger than a width of said opening.

4. The sun visor extension of claim 1 wherein a second portion is attached or integral with an outer end of each of said arms, said second end portion having a width which is thicker than a width of said arms.

5. The sun visor extension of claim 4 wherein a thickness of said second portion is greater than a thickness of said arms.

6. The sun visor of claim 5 further comprising an indentation in said second portion.

7. The sun visor extension of claim 1 wherein said arms are formed of a plastic material.

8. The sun visor extension of claim 1 wherein said arms are formed of a polarized plastic material.

9. The sun visor extension of claim 1 wherein said housing is formed of plastic or cardboard.

10. The sun visor extension of claim 1 wherein said mounting means comprises:
a first portion of a hook and loop material attached to said housing; and
a second portion of a hook and loop material adapted to be attached above the rearview mirror.

11. A method for blocking an area between a pair of sun visors comprising the steps of:
mounting a sun visor extension to a rearview mirror or above the rearview mirror, said sun visor extension comprising: a housing; a pair of arms slideably extending from an opening in said housing; and a mounting means attached to said housing for mounting said housing to a portion of the rearview mirror or above the rearview mirror and extending one or more of said arms from said opening in said housing.

12. The method of claim 11 wherein said mounting means comprises:
a first portion of a hook and loop material attached to said housing; and
a second portion of a hook and loop material adapted to be attached to a portion of a rearview mirror.

13. The method of claim 11 wherein a first end portion is attached or integral with an inner end of each of said arms, said first end portion having a width which is larger than a width of said opening.

14. The method of claim 11 wherein a second portion is attached or integral with an outer end of each of said arms, said second end portion having a width which is thicker than a width of said arms.

15. The method of claim 11 wherein a thickness of said second portion is greater than a thickness of said arms.

16. The method of claim 15 further comprising an indentation in said second portion.

17. The method of claim 11 wherein said arms are formed of a plastic material.

18. The method of claim 11 wherein said arms are formed of a polarized plastic material.

19. The method of claim 11 wherein said housing is formed of plastic or cardboard.

20. The method of claim 11 wherein said mounting means comprises:
a first portion of a hook and loop material attached to said housing; and
a second portion of a hook and loop material adapted to be attached above the rearview mirror.
